(19) United States
(12) Patent Application Publication
(10) Pub. No.: US 2025/0128550 A1
(43) Pub. Date: Apr. 24, 2025

(54) TIRE MONITORING SYSTEM AND TIRE MONITORING METHOD

(71) Applicant: TOYO TIRE CORPORATION, Itami-shi (JP)

(72) Inventors: Sachiko NAKAJIMA, Itami-shi (JP); Akio YOSHINARI, Itami-shi (JP)

(21) Appl. No.: 18/919,718

(22) Filed: Oct. 18, 2024

(30) Foreign Application Priority Data
Oct. 20, 2023 (JP) 2023-181369

(51) Int. Cl. B60C 23/04

(52) U.S. Cl. CPC B60C 23/0476; B60C 23/0479

(57) ABSTRACT

A tire monitoring system includes an information acquisition unit, a temperature determination unit, and an inflation pressure determination unit. The information acquisition unit acquires measurement data by an inflation pressure sensor and a temperature sensor. The temperature determination unit determines whether the measurement data for temperature is higher than a predetermined threshold value based on the measurement data acquired by the information acquisition unit. The inflation pressure determination unit determines, when the temperature determination unit determines that the temperature is higher than the predetermined threshold value, whether a high temperature state in the tire is caused by a factor on a vehicle side or a tire side based on the measurement data for inflation pressure.

### CROSS-REFERENCE TO RELATED APPLICATION

This application is based upon and claims the benefit of priority from the prior Japanese Patent Application No. 2023-181369, filed on Oct. 20, 2023, the entire contents of which are incorporated herein by reference.

### BACKGROUND

### 1. Field of the Disclosure

The present disclosure relates to a tire monitoring system and a tire monitoring method for managing a tire mounted on a vehicle.

### 2. Description of the Related Art

Tires mounted on a vehicle are set to an appropriate inflation pressure. When the inflation pressure drops, the tire is filled with air in a maintenance operation to produce a proper inflation pressure again.

Patent Literature 1 describes a related-art tire internal pressure alert system. The tire internal pressure alert system is comprised of a TPMS sensor transmitter and a TPMS receiver, which constitute an internal pressure acquisition apparatus that acquires the internal pressure of each tire of a vehicle, and an information terminal apparatus that determines a trouble status, i.e., whether a puncture has occurred or the pressure has decreased naturally, based on a change in the internal pressure of each tire received from the TPMS receiver and that displays an alert according to the trouble situation.

Patent Literature 1: Japanese Unexamined Patent Application Publication No. 2014-76748

### SUMMARY

The tire internal pressure alert system described in Patent Literature 1 compares the inflation pressure of each tire with a threshold value to determine whether the tire is punctured. We have considered that there is room to improve vehicle and tire maintainability for resolving a trouble, by monitoring whether a trouble of a high temperature state of the tire is caused by a factor on the tire side or the vehicle side.

The present disclosure addresses the issue described above, and a purpose thereof is to provide a tire monitoring system and a tire monitoring method capable of determining a factor that caused a high temperature state of a tire and improving maintainability.

A tire monitoring system according to an embodiment of the present disclosure includes: an information acquisition unit that acquires measurement data by an inflation pressure sensor and a temperature sensor provided in a tire mounted on a vehicle; a temperature determination unit that determines whether the measurement data for temperature is higher than a predetermined threshold value based on the measurement data acquired by the information acquisition unit; an inflation pressure determination unit that determines, when the temperature determination unit determines that the temperature is higher than the predetermined threshold value, whether a high temperature state in the tire is caused by a factor on a vehicle side or a tire side based on the measurement data for inflation pressure.

Another embodiment of the present disclosure relates to a tire monitoring method. The tire monitoring method includes: acquiring measurement data by an inflation pressure sensor and a temperature sensor provided in a tire mounted on a vehicle; determining whether the measurement data for temperature is higher than a predetermined threshold value based on the measurement data acquired by the acquiring; and, when the determining determines that the temperature is higher than the predetermined threshold value, determining whether a high temperature state in the tire is caused by a factor on a vehicle side or a tire side based on the measurement data for inflation pressure.

### BRIEF DESCRIPTION OF THE DRAWINGS

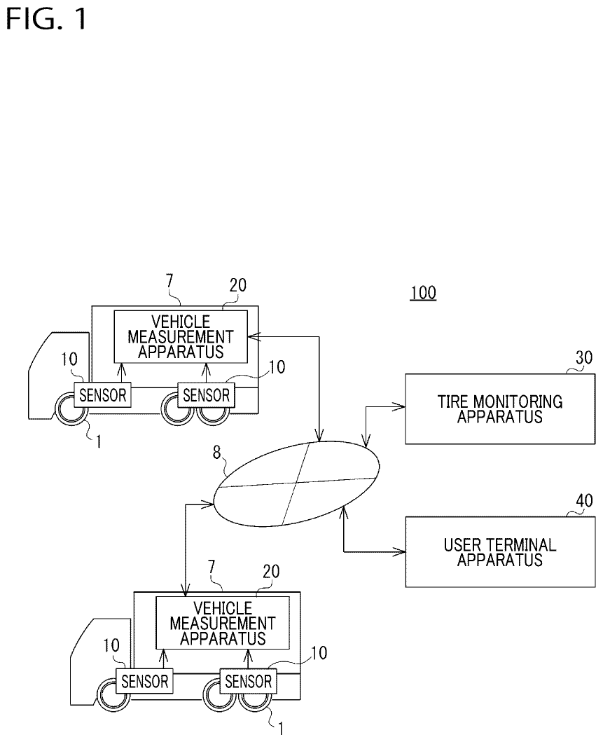

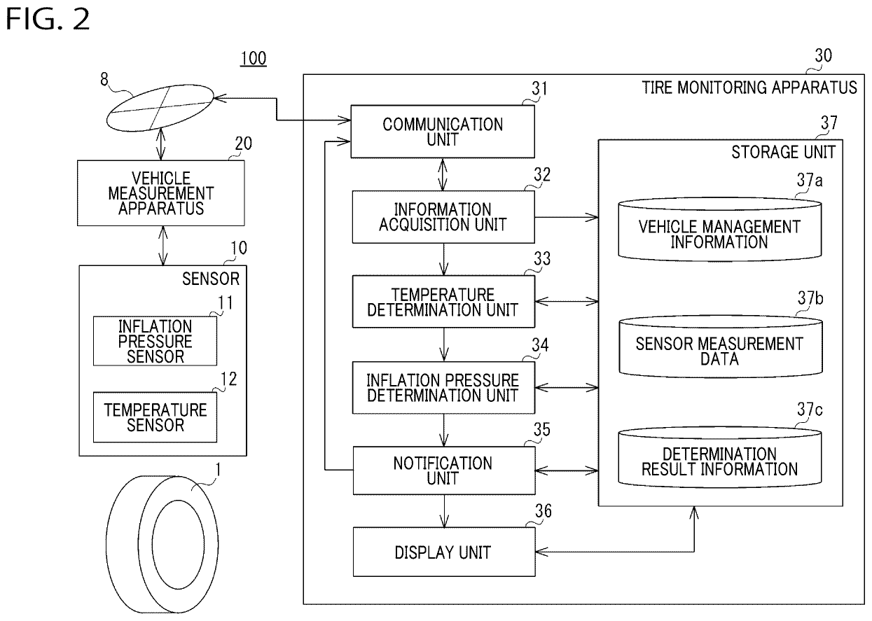

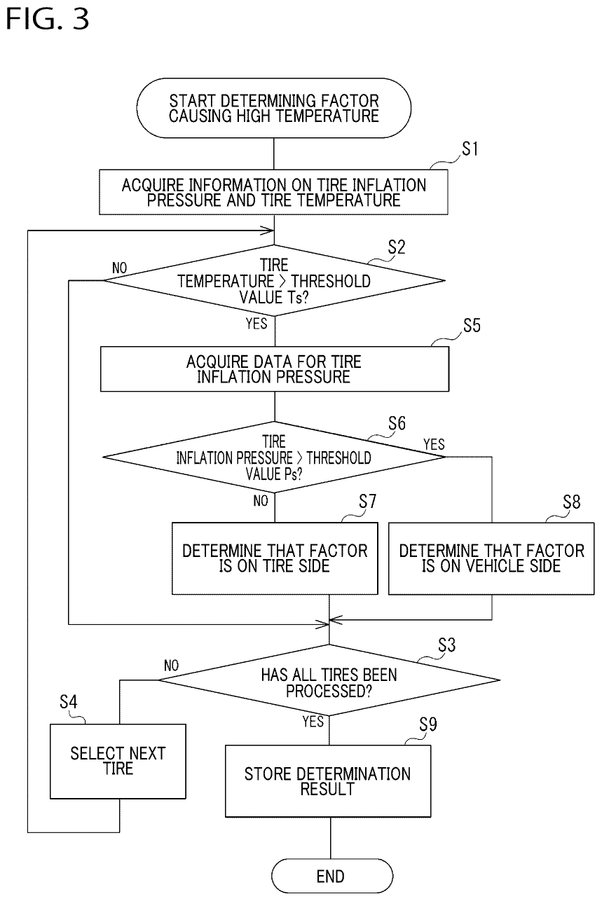

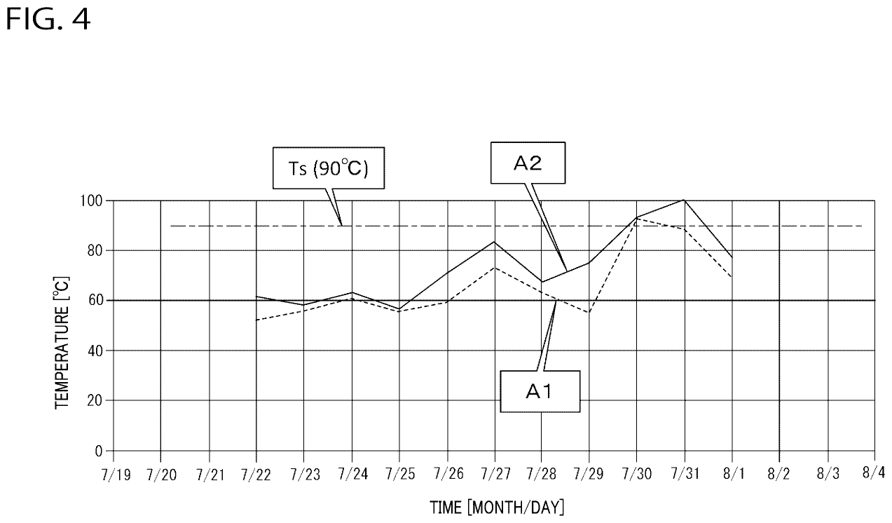

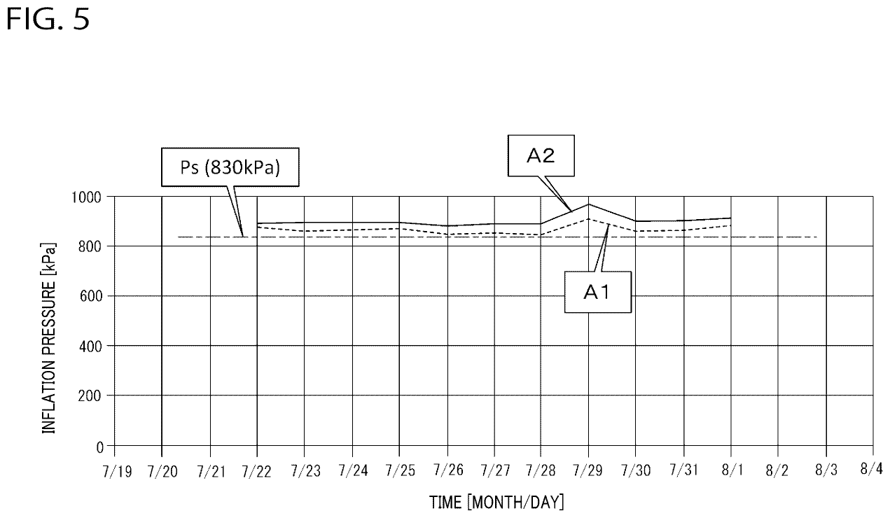

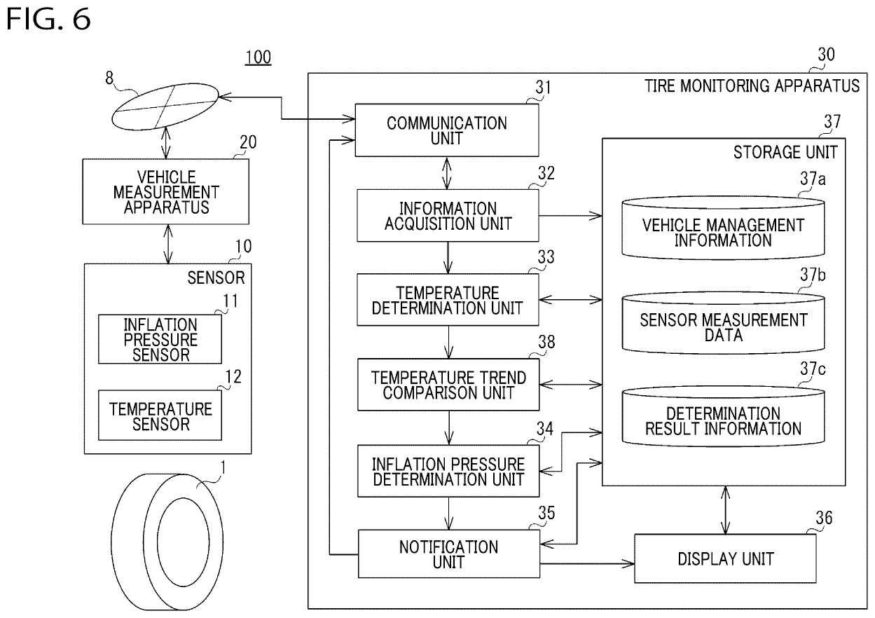

Embodiments will now be described, by way of example only, with reference to the accompanying drawings which are meant to be exemplary, not limiting, and wherein like elements are numbered alike in several Figures, in which: FIG. 1 is a schematic diagram showing an overall configuration of a tire monitoring system according to the embodiment; FIG. 2 is a block diagram showing a functional configuration of the tire monitoring apparatus; FIG. 3 is a flowchart showing steps performed by the tire monitoring system to determine a factor that caused high temperature; FIG. 4 is a graph showing examples of tire temperature measured when a high temperature state of a tire occurs; FIG. 5 is a graph showing examples of tire inflation pressure for which the high temperature state is determined to be caused by a factor on the vehicle side; and FIG. 6 is a block diagram showing a functional configuration of a tire monitoring apparatus according to a variation.

### DETAILED DESCRIPTION

The invention will now be described by reference to the preferred embodiments. This does not intend to limit the scope of the present invention, but to exemplify the invention. Hereinafter, the present disclosure will be described based on a preferred embodiment with reference to FIG. 1 through FIG. 6. Identical or like constituting elements and members shown in the drawings are represented by identical symbols, and a duplicate description will be omitted as appropriate. The dimension of the members in the drawings shall be enlarged or reduced as appropriate to facilitate understanding. Those of the members that are not material to the description of the embodiments are omitted in the drawings.

### Embodiment

FIG. 1 is a schematic diagram showing an overall configuration of a tire monitoring system 100 according to the embodiment. The tire monitoring system 100 includes a sensor 10, a vehicle measurement apparatus 20, a tire monitoring apparatus 30, a user terminal apparatus 40, etc. The tire monitoring system 100 acquires and monitors measurement data such as inflation pressure and temperature of a tire 1 measured by the sensor 10 provided in a plurality of tires 1 mounted on a vehicle 7. The vehicle 7 is, for example, a transport truck operated under the management of a transport company, etc. A plurality of tires 1 are mounted on the vehicle 7.

The tire monitoring apparatus 30 of the tire monitoring system 100 determines whether the tire temperature of the plurality of tires 1 is in a high temperature state. When it is determined that the tire 1 is in a high temperature state, the tire monitoring apparatus 30 determines whether the high temperature state is caused by a factor on the vehicle side or the tire side based on the measurement data for tire inflation pressure.

The tire monitoring apparatus 30 generates alert information including a determination result indicating that the tire 1 is in a high temperature state and indicating whether it is caused by a factor on the vehicle side or the tire side and outputs the alert information outside. The tire monitoring apparatus 30 outputs the alert information outside by displaying the alert information on a display device included in the apparatus itself. Further, the tire monitoring apparatus 30 outputs the alert information outside by transmitting an e-mail, etc. including the alert information and destined to the user.

The user obtains the alert information by viewing the alert information displayed on the display apparatus. Alternatively, the user receives an e-mail, etc. in the user terminal apparatus 40 and acquires the alert information. The user can know the alert information output outside by the tire monitoring apparatus 30 and plan maintenance of the vehicle and the tire.

FIG. 2 is a block diagram showing a functional configuration of the tire monitoring apparatus 30. The sensor 10 includes an inflation pressure sensor 11 and a temperature sensor 12 provided in the tire 1. The inflation pressure sensor 11 measures a tire inflation pressure. The temperature sensor 12 measures a tire temperature. The inflation pressure sensor 11 and the temperature sensor 12 are provided in, for example, an air valve of the tire 1. The temperature sensor 12 may be provided directly in the tire 1 to measure the temperature of the tire 1 accurately.

The vehicle measurement apparatus 20 accumulates measurement data for tire inflation pressure and tire temperature measured by the sensor 10 and transmits the data to the tire monitoring apparatus 30 via a communication network 8. For example, the vehicle measurement apparatus 20 transmits the stored measurement data to the tire monitoring apparatus 30 every several minutes to several tens of minutes. The time interval for transmission of the measurement data from the vehicle measurement apparatus 20 to the tire monitoring apparatus 30 is not limited to several minutes to several tens of minutes. The measurement data transmitted from the vehicle measurement apparatus 20 to the tire monitoring apparatus 30 also includes information on the mounting position of each tire subject to measurement in the axle arrangement.

The tire monitoring apparatus 30 includes a communication unit 31, an information acquisition unit 32, a temperature determination unit 33, an inflation pressure determination unit 34, a notification unit 35, a display unit 36, and a storage unit 37. The parts in the tire monitoring apparatus 30 are implemented in hardware such as an electronic processing circuit comprised of an electronic element exemplified by a CPU of a computer, a mechanical component, etc., and in software such as a computer program. FIG. 2 depicts functional blocks implemented by the cooperation of these parts. Therefore, it will be understood by those skilled in the art that the functional blocks may be implemented in a variety of manners by a combination of hardware and software.

The communication unit 31 is communicably connected with the communication network 8 by wireless or wired communication and communicates with the vehicle measurement apparatus 20. The information acquisition unit 32 acquires the measurement data for tire inflation pressure and tire temperature transmitted by the vehicle measurement apparatus 20 via the communication unit 31. It will be assumed that the measurement data acquired by the information acquisition unit 32 is mapped to the identification information on the vehicle 7. The information acquisition unit 32 stores the measurement data for tire inflation pressure and tire temperature thus acquired in the storage unit 37. Further, the information acquisition unit 32 outputs the information on tire temperature thus acquired to the temperature determination unit 33.

The storage unit 37 is a storage apparatus comprised of, for example, an SSD (Solid State Drive), a hard disk, a CD-ROM, a DVC, etc. The storage unit 37 stores vehicle management information 37a, sensor measurement data 37b, and determination result information 37c.

The vehicle management information 37a is, for example, information related to a plurality of vehicles 7 operated under the management of a transport company, etc. The vehicle management information 37a includes the name of the vehicle 7, identification information on the vehicle 7 attached to each vehicle, axle arrangement information, etc. The axle arrangement information includes information on the mounting position of the tire in the axle arrangement.

The sensor measurement data 37b is the measurement data for tire inflation pressure and tire temperature acquired by the information acquisition unit 32 in association with each vehicle 7 included in the vehicle management information 37a. The sensor measurement data 37b includes information on the date and time when the tire inflation pressure and the tire temperature are measured. The determination result information 37c is generated by the inflation pressure determination unit 34 and stored in the storage unit 37.

The temperature determination unit 33 determines whether the tire temperature is higher than a predetermined threshold value Ts based on the measurement data acquired by the information acquisition unit 32 within a predetermined period. Normally, the temperature of the tire 1 is affected by outside temperature dependent on the season and rises while the vehicle 7 is running. Given that the temperature on the high temperature side of the normally operated tire 1 is about 70° C., for example, there is a possibility that some trouble has occurred on the vehicle side and the tire side in a state where the tire temperature becomes as high as 80° C. or 90° C.

The temperature determination unit 33 sets the threshold value Ts in the range of, for example, 80° C. to 90° C. and determines whether the tire temperature rises beyond the normal range. The threshold value Ts set in the temperature determination unit 33 is not limited to the range of 80° C. to 90°° C. and may be variable in association with fluctuations in outside temperature dependent on the season.

When the temperature determination unit 33 determines that the tire temperature is higher than the threshold value Ts, the temperature determination unit 33 outputs the determination result to the storage unit 37 and causes the storage unit 37 to store the determination result as the determination result information 37c. The determination result information 37c includes the tire temperature, identification information on the corresponding vehicle 7, information on the mounting position of the tire 1 in the axle arrangement, information on the date and time, etc. Further, when the temperature determination unit 33 determines that the tire temperature is higher than the threshold value Ts, the temperature determination unit 33 outputs the determination result to the inflation pressure determination unit 34. Even after determining that the tire temperature is higher than the threshold value Ts, the temperature determination unit 33 compares the tire temperature with the threshold value Ts and outputs the determination result to the inflation pressure determination unit 34 and the notification unit 35.

When the determination result is input from the temperature determination unit 33, the inflation pressure determination unit 34 determines whether the inflation pressure of the tire 1 is larger than a predetermined threshold value Ps. When the inflation pressure determination unit 34 determines that the inflation pressure of the tire 1 is larger than the threshold value Ps, the inflation pressure determination unit 34 determines that the high temperature state of the tire 1 is caused by factor such as a mechanical component on the vehicle side. When the inflation pressure determination unit 34 determines that the inflation pressure of the tire 1 is equal to or below the threshold value Ps, the inflation pressure determination unit 34 determines that the high temperature state of the tire 1 is caused by a factor such as a decrease in inflation pressure on the tire side.

Generally, a significant drop in tire inflation pressure is considered to result in lower rigidity of the tire, increase in mechanical vibration in the tire during vehicle travel, and increase in tire temperature. For this reason, the inflation pressure determination unit 34 determines that the high temperature state of the tire 1 is caused by factor such as a decrease in inflation pressure on the tire side when the tire inflation pressure is equal to or below the threshold value Ps.

When the tire inflation pressure is larger than the threshold value Ps, the inflation pressure determination unit 34 determines that the high temperature state of the tire 1 is caused by a factor such as a mechanical component on the vehicle side rather than a factor on the tire side. A mechanical component on the vehicle side is exemplified by a bearing provided in the hub portion, a brake component, etc. Heat generated when, for example, friction grows in a mechanical component, etc. on the vehicle side may be conducted to the tire side to result in a high temperature state of the tire 1.

The inflation pressure determination unit 34 may read the inflation pressure data for a predetermined period including the point of time of occurrence of the high temperature state in the tire 1 from the sensor measurement data 37b and determine whether the tire inflation pressure is larger than the threshold value Ps. The predetermined period is, for example, 1 week-1 month but is not limited to this range.

Further, the inflation pressure determination unit 34 may calculate an average value of tire inflation pressure using a known statistical method. The inflation pressure determination unit 34 may, for example, determine a regression line from the distribution of tire inflation pressure in a predetermined period until the point of time of occurrence of the high temperature state in the tire 1 and calculate a tire inflation pressure at the point of time of occurrence of the high temperature state in the tire 1.

The inflation pressure determination unit 34 outputs the determination result regarding a factor that caused the high temperature state in the tire 1 to the storage unit 37 and causes the storage unit 37 to store the determination result as the determination result information 37c. The determination result information 37c corresponds to the determination result given by the temperature determination unit 33 described above, and information indicating whether the high temperature state in the tire 1 is caused by a factor on the vehicle side or the tire side is added to the determination result.

The notification unit 35 reads the determination result information 37c from the storage unit 37 and generates alert information including the tire temperature, cause of occurrence, identification information on the corresponding vehicle 7, information on the mounting position of the tire 1 in the axle arrangement, information on the date and time, etc. The notification unit 35 outputs the generated alert information outside.

The notification unit 35 may output the alert information to the display unit 36 included in the tire monitoring apparatus 30 to display the alert information using the display unit 36 and notify the user accordingly. The display unit 36 includes a display apparatus such as a liquid crystal display and displays the alert information input from the notification unit 35 on the display apparatus.

The display unit 36 may read the measurement data for tire temperature and tire inflation pressure of the vehicle 7 corresponding to the alert information from the sensor measurement data 37b in the storage unit 37 and display the measurement data on the display apparatus. The display unit 36 lets the user know changes in tire temperature and tire inflation pressure by, for example, displaying a transition in tire temperature and tire inflation pressure for a predetermined period (several months) on the display apparatus.

The notification unit 35 may generate an e-mail including the generated alert information and transmit the e-mail to an e-mail address owned by the user. The user can receive the e-mail transmitted by the notification unit 35 and know the alert information, using an application, etc. for transmission/reception of e-mails in the tire monitoring apparatus 30 and the user terminal apparatus 40. The user terminal apparatus 40 is, for example, an information processing apparatus such as a smartphone and a personal computer.

When the inflation pressure determination unit 34 determines that the high temperature state in the tire 1 is caused by a factor on the vehicle side, the notification unit 35 may generate alert information including a stop instruction to stop the vehicle 7 to notify the driver of the vehicle 7, the user who manages vehicle operation, etc. accordingly.

Further, when the determination result indicating that the temperature of the tire 1 is lower than the threshold value Ts is input by the temperature determination unit 33 after the notification unit 35 outputs the alert information including the stop instruction to stop the vehicle 7, the notification unit 35 may generate alert information including information indicating that it is possible to resume driving the vehicle 7 to notify the driver of the vehicle 7, the user who manages vehicle operation, etc. accordingly.

A description will now be given of the operation of the tire monitoring system 100. FIG. 3 is a flowchart showing steps performed by the tire monitoring system 100 to determine a factor that caused high temperature. Hereinafter, an example of performing a determination in association with a vehicle selected in advance by the user will be described, but similar steps may be performed sequentially for a plurality of vehicles that are operated under management. The information acquisition unit 32 of the tire monitoring apparatus 30 acquires measurement data for tire inflation pressure and tire temperature from the vehicle measurement apparatus 20 (S1). The information acquisition unit 32 outputs the acquired measurement data for tire inflation pressure and tire temperature to the storage unit 37 and causes the storage unit 37 to store the measurement data.

The temperature determination unit 33 reads the sensor measurement data 37b corresponding to the selected vehicle from the storage unit 37 and determines whether the tire temperature of one tire 1 mounted on the vehicle is higher than the threshold value Ts (S2).

When a negative determination is made in step S2 (S2: NO), the temperature determination unit 33 determines whether all tires of the vehicle have been processed (S3).

When a negative determination is made in step S3 (S3: NO), the temperature determination unit 33 selects the next tire (S4), returns to step S2, and repeats the process.

When it is determined in step S2 that the tire temperature is higher than the threshold value Ts (S2: YES), the inflation pressure determination unit 34 reads and acquires the data of the sensor measurement data 37b for tire inflation pressure from the storage unit 37 (S5). The inflation pressure determination unit 34 determines whether the tire inflation pressure is larger than the threshold value Ps (S6). When a negative determination is made in step S6 (S6: NO), the inflation pressure determination unit 34 determines that the high temperature state of the tire 1 is caused by a factor on the tire side (S7). After step S7, the process proceeds to step S3 and is continued.

When it is determined in step S6 that the tire inflation pressure is larger than the threshold value Ps (S6: YES), the inflation pressure determination unit 34 determines that the high temperature state of the tire 1 is caused by a factor on the vehicle side (S8). After step S8, the process proceeds to step S3 and is continued.

When it is determined in step S3 that the process has been completed for all tires of the vehicle, the inflation pressure determination unit 34 outputs the determination results of steps S7 and S8 to the storage unit 37 to cause the storage unit 37 to store the results (S9) before terminating the process.

FIG. 4 is a graph showing examples of tire temperature measured when a high temperature state of a tire occurs, and FIG. 5 is a graph showing examples of tire inflation pressure for which the high temperature state is determined to be caused by a factor on the vehicle side. In FIGS. 4 and 5, the horizontal axis represents time, and the vertical axes represent tire temperature and tire inflation pressure. In the examples shown in FIGS. 4 and 5, 10 tires 1 are, for example, mounted on one truck vehicle, and the tire temperature in two tires 1 out of the 10 tires 1 is in a high temperature state.

Referring to FIG. 4, the threshold value Ts of tire temperature is 90° C., and the temperature of the tires A1 and A2 is in a high temperature state beyond the threshold value Ts on July 30. Meanwhile, the inflation pressure of the tires A1 and A2 is larger than the threshold value Ps (e.g., 830 kPa) (see FIG. 5). In this case, it can be seen that the high temperature state in the tires A1 and A2 is caused by a factor on the vehicle side.

The pressure of the tires A1 and A2 increased on July 29 and decreased on July 30. Given that the predetermined period for determining the tire inflation pressure is 11 days from July 22 to August 1, the inflation pressure of the tires A1 and A2 on July 30 generally remains unchanged from the inflation pressure on days within the predetermined period other than July 29. The inflation pressure determination unit 34 may, for example, determine whether the data, average value, etc. for tire inflation pressure in the 11-day predetermined period from July 22 to August 1 is larger than the threshold value Ps.

In the examples shown in FIGS. 4 and 5, the temperature determination unit 33 of the tire monitoring apparatus 30 determines that the tire 1 is in a high temperature state beyond the threshold value Ts. The inflation pressure determination unit 34 determines that there is no problem on the tire side and that the high temperature state is caused by a factor on the vehicle side. In the examples shown in FIGS. 4 and 5, it is known that the tire temperature has risen due to the heat actually generated in the brake portion in the vicinity of the tires A1 and A2. The tire monitoring system 100 uses the

information acquisition unit 32 to acquire the measurement data measured by the inflation pressure sensor 11 and the temperature sensor 12 provided in the tire 1 mounted on the vehicle 7 and uses the temperature determination unit 33 to determine whether the measurement data for temperature is higher than the predetermined threshold value Ts based on the measurement data. When the inflation pressure determination unit 34 of the tire monitoring system 100 determines by the temperature determination unit 33 that the temperature is higher than the predetermined threshold value Ts, the inflation pressure determination unit 34 determines whether the high temperature state in the tire 1 is caused by a factor on the vehicle side or the tire side. Thereby, the tire monitoring system 100 can determine a factor that caused the high temperature state of the tire 1 and improve maintainability of the vehicle 7 and the tire 1.

Further, the inflation pressure determination unit 34 of the tire monitoring system 100 determines that the high temperature state in the tire 1 is caused by a factor on the vehicle side when the inflation pressure of the tire 1 is larger than the predetermined threshold value Ps. Thereby, the tire monitoring system 100 can determine that the high temperature state in the tire 1 is caused by a factor on the vehicle side.

Further, the inflation pressure determination unit 34 of the tire monitoring system 100 makes a determination based on the inflation pressure data for a predetermined period including the point of time of occurrence of the high temperature state in the tire 1. Thereby, the tire monitoring system 100 can more accurately determine a factor that caused the high temperature state of the tire 1, using a trend in time-dependent change of the inflation pressure within the predetermined period.

Further, the notification unit 35 of the tire monitoring system 100 outputs the result determined by the inflation pressure determination unit 34 outside. Thereby, the tire monitoring system 100 can let the user, etc. know the determination result regarding a factor that caused the high temperature state in the tire 1 mounted on the vehicle 7.

Further, when it is determined that the high temperature state in the tire 1 is caused by a factor on the vehicle side, the notification unit 35 of the tire monitoring system 100 may generate alert information including a stop instruction to stop the vehicle 7 to notify the driver of the vehicle 7, the user who manages vehicle operation, etc. accordingly. Thereby, the tire monitoring system 100 can prompt the driver, the user, etc. not to continue driving the vehicle 7 in the presence of a trouble on the vehicle side. Further, in the case the vehicle 7 is running by automatic driving, control may be exercised to stop the vehicle 7 automatically by outputting the stop instruction to the vehicle 7.

Further, when a determination result indicating that the temperature of the tire 1 is lower than the threshold value Ts is input by the temperature determination unit 33 after the notification unit 35 of the tire monitoring system 100 outputs the alert information including the stop instruction to stop the vehicle 7, the notification unit 35 may generate alert information including information indicating that it is possible to resume driving the vehicle 7 to notify the driver of the vehicle 7 or the user who manages vehicle operation accordingly. Thereby, the tire monitoring system 100 can confirm that the state of abnormal temperature has been alleviated and let the driver or the user know that the vehicle may be moved for repair or inspection. Further, in the case the vehicle 7 is running by automatic driving, control may be exercised to allow the vehicle 7 to resume running automatically and move to a service site, etc. by outputting an instruction indicating that it is possible to resume running to the vehicle 7.

### Variation

When a determination result indicating that the tire 1 is in a high temperature state is input from the temperature determination unit 33, the inflation pressure determination unit 34 may determine whether the amount of decrease in inflation pressure is smaller than a predetermined threshold value Pt. In this case, when the inflation pressure determination unit 34 determines that the amount of decrease in inflation pressure is smaller than the threshold value Pt, the inflation pressure determination unit 34 determines that the high temperature state of the tire 1 is caused by a factor such as a mechanical component on the vehicle side. When the inflation pressure determination unit 34 determines that the amount of decrease in inflation pressure is equal to or larger than the threshold value Pt, the inflation pressure determination unit 34 determines that the high temperature state of the tire 1 is caused by a factor such as a decrease in inflation pressure on the tire side. It is assumed that the inflation pressure determination unit 34 uses an absolute value as the amount of decrease in inflation pressure.

The inflation pressure determination unit 34 reads the inflation pressure data for a predetermined period including the point of time of occurrence of the high temperature state in the tire 1 from the sensor measurement data 37b and determines whether the amount of decrease in tire inflation pressure is smaller than the threshold value Pt. The predetermined period is, for example, 1 week-1 month, but is not limited to this range. The inflation pressure determination unit 34 calculates an average value of the tire inflation pressure in a period before the occurrence of the high temperature state in the tire 1 and calculates an amount of decrease in tire inflation pressure at the point of time of occurrence of the high temperature state in the tire 1.

Further, the inflation pressure determination unit 34 may calculate an amount of decrease in tire inflation pressure using a known statistical method. The inflation pressure determination unit 34 may, for example, determine a regression line from the distribution of tire inflation pressure in a period until the point of time of occurrence of the high temperature state in the tire 1 and calculate an amount of decrease in tire inflation pressure at the point of time of occurrence of the high temperature state in the tire 1.

Referring to FIG. 5, the amount of decrease in inflation pressure in the tires A1 and A2 is smaller than the threshold value Pt (e.g., 100 kPa), and it can be seen that the high temperature state in the tires A1 and A2 is caused by a factor on the vehicle side. The tire monitoring system 100 can determine whether the high temperature condition in the tire 1 is caused by a factor on the vehicle side or the tire side by determining whether the amount of decrease in inflation pressure is smaller than the predetermined threshold value Pt.

FIG. 6 is a block diagram showing a functional configuration of a tire monitoring apparatus according to a variation. The tire monitoring apparatus 30 according to the variation shown in FIG. 6 includes a temperature trend comparison unit 38 and determines, when only one tire 1 out of the plurality of tire 1 mounted on the vehicle 7 is in a high temperature state, whether the high temperature state is caused by a factor on the vehicle side or the tire side. The tire monitoring apparatus 30 according to the modification defines one tire of the plurality of tire 1 mounted on the vehicle 7 as the “first tire 1”, defines the other plurality of tires as the “second tire 1”, and defines that the first inflation pressure sensor 11 and the first temperature sensor 12 are attached to the first tire 1, and the second inflation pressure sensor 11 and the second temperature sensor 12 are attached to the second tire 1. It is noted that there are a plurality of second tires 1, and the second inflation pressure sensor 11 and the second temperature sensor 12 are provided for each second tire 1 and that the second inflation pressure sensor 11 and the second temperature sensor 12 are comprised of a plurality of inflation pressure sensors 11 and a temperature sensor 12, respectively.

The information acquisition unit 32 acquires the measurement data of the first inflation pressure sensor 11, the second inflation pressure sensor 11, the first temperature sensor 12, and the second temperature sensor 12. The temperature determination unit 33 determines whether the measurement data for temperature measured by the first temperature sensor 12 and the second temperature sensor 12 is higher than the predetermined threshold value Ts. When the temperature determination unit 33 determines that the temperature of the first temperature sensor 12 is higher than the predetermined threshold value Ts, the temperature trend comparison unit 38 compares the trend of tire temperature measured by the first temperature sensor 12 and the second temperature sensor 12 (or the trend of change in tire temperature).

The temperature trend comparison unit 38 determines whether the tire temperature of each tire 1 is on an upward trend or a downward trend and determines whether the trend of tire temperature measured by the first temperature sensor 12 and the trend of tire temperature measured by the second temperature sensor 12 are identical or different. The temperature trend comparison unit 38 may use a plurality of threshold values to determine an upward trend or a downward trend of the tire temperature in multiple stages according to the amount of change in temperature.

When the temperature trend comparison unit 38 determines that the temperature trend of the first temperature sensor 12 and that of the second temperature sensor 12 differ, the inflation pressure determination unit 34 determines whether the high temperature state in the first tire 1 is caused by a factor on the vehicle side or the tire side. The inflation pressure determination unit 34 may make a determination by the same method as in the embodiment and the variation described above. By determining, when only one tire 1 is in a high temperature state, whether the high temperature state is caused by a factor on the vehicle side or the tire side, the tire monitoring system 100 can identify that the state is occurring locally on the axle of the vehicle 7 and, at the same time, determine a factor that caused the high temperature state of the tire 1.

It is ensured that one of the plurality of tires 1 mounted on the vehicle 7 is sequentially selected as the first tire 1, and the sensors attached to the selected first tire are defined as the first inflation pressure sensor 11 and the first temperature sensor 12. A plurality of tires 1 other than the selected first tire 1 are selected as the second tire 1, and the sensors attached to these tires 1 are defined as the second inflation pressure sensor 11 and the second temperature sensor 12. The temperature determination unit 33, the temperature trend comparison unit 38, and the inflation pressure determination unit 34 may perform calculation and determination based on the tire inflation pressure and the tire temperature in the sequentially selected first tire 1 and the plurality of second tires 1.

The temperature determination unit 33 may read the sensor measurement data 37b acquired for the plurality of tires 1 mounted on the vehicle 7 from the storage unit 37 and identify, when the temperature of one of the tires 1 is in a high temperature state beyond the threshold value Ts, that one tire as the first tire 1. The temperature trend comparison unit 38 may determine and compare the trend in tire temperature in the first tire 1 identified by the temperature determination unit 33 and the trend in tire temperature in the second tire 1 other than the first tire 1 mounted on the vehicle 7. When the temperature trend comparison unit 38 determines that the temperature trend of the first temperature sensor 12 and that of the second temperature sensor 12 differ, the inflation pressure determination unit 34 may determine whether the high temperature state in the first tire 1 is caused by a factor on the vehicle side or the tire side based on the measurement data for tire inflation pressure.

In the embodiment and the variation described above, the threshold value Ts, the threshold value Ps, the threshold value Pt, and the predetermined period are described by way of example, but each threshold value and predetermined period are not limited thereto. Numerical values may be defined based on past cases where the tire 1 was in a high temperature state or detailed design analysis of the tire 1.

The transport company is not limited to a company that operates a transport truck under its management, and includes, for example, a taxi company. Further, the vehicle 7 is not limited to a truck vehicle, a taxi vehicle, etc. but also includes a vehicle for rental of a rental company, a vehicle for sharing provided by a vehicle sharing company, a private car purchased in a general household, etc.

Given above is a description based on the embodiment of the present disclosure. The embodiment is intended to be illustrative only and it will be understood to those skilled in the art that variations and modifications are possible within the claim scope of the present disclosure and that such variations and modifications are also within the claim scope of the present disclosure. Accordingly, the description and drawings in the specification shall be interpreted as being illustration instead of limitation.

To generalize the technical idea embodied by the embodiment and the variation, the technical idea defined by the following items can be said to be covered.

Item 1 relates to a tire monitoring system including: an information acquisition unit that acquires measurement data by an inflation pressure sensor and a temperature sensor provided in a tire mounted on a vehicle; a temperature determination unit that determines whether the measurement data for temperature is higher than a predetermined threshold value based on the measurement data acquired by the information acquisition unit; an inflation pressure determination unit that determines, when the temperature determination unit determines that the temperature is higher than the predetermined threshold value, whether a high temperature state in the tire is caused by a factor on a vehicle side or a tire side based on the measurement data for inflation pressure.

Item 2 relates to the tire monitoring system according to item 1, wherein, when the inflation pressure is higher than the predetermined threshold value, the inflation pressure determination unit determines that the high temperature state in the tire is caused by a factor on the vehicle side.

Item 3 relates to the tire monitoring system according to any one of item 1 through item 2, wherein the inflation pressure determination unit makes a determination based on inflation pressure data for a predetermined period including a point of time of occurrence of the high temperature state in the tire.

Item 4 relates to the tire monitoring system according to any one of item 1 through item 3, further including: a notification unit that outputs a result of determination by the inflation pressure determination unit outside.

Item 5 relates to the tire monitoring system according to item 4, wherein the notification unit outputs a stop instruction to stop the vehicle when the inflation pressure determination unit determines that the high temperature state in the tire is caused by a factor on the vehicle side.

Item 6 relates to the tire monitoring system according to item 5, wherein, when the temperature determination unit determines that the temperature of the tire is lower than the threshold value after the notification unit outputs the stop instruction, the notification unit notifies that running of the vehicle can be resumed.

Item 7 relates to a tire monitoring method including: acquiring measurement data by an inflation pressure sensor and a temperature sensor provided in a tire mounted on a vehicle; determining whether the measurement data for temperature is higher than a predetermined threshold value based on the measurement data acquired by the acquiring; and, when the determining determines that the temperature is higher than the predetermined threshold value, determining whether a high temperature state in the tire is caused by a factor on a vehicle side or a tire side based on the measurement data for inflation pressure.

Item 8 relates to a tire inflation pressure monitoring system including: a first inflation pressure sensor and a first temperature sensor provided in a first tire of a plurality of tires mounted on a vehicle; a second inflation pressure sensor and a second temperature sensor provided in a second tire other than the first tire; an information acquisition unit that acquires measurement data by the first inflation pressure sensor, the first temperature sensor, the second inflation pressure sensor and the second temperature sensor; a temperature determination unit that determines whether the measurement data for temperature is higher than a predetermined threshold value based on the measurement data acquired by the information acquisition unit; a temperature trend comparison unit that compares a trend in temperature of the first temperature sensor and the second temperature sensor when the temperature determination unit determines that the temperature is higher than the predetermined threshold value; an inflation pressure determination unit that determines, when the temperature trend comparison unit determines that the trend in temperature of the first temperature sensor and that of the second temperature sensor differ, whether a high temperature state in the tire is caused by a factor on a vehicle side or a tire side based on the measurement data for inflation pressure.

What is claimed is:

1. A tire monitoring system comprising:
an inflation pressure sensor and a temperature sensor provided in a tire mounted on a vehicle;
an information acquisition unit that acquires measurement data by the inflation pressure sensor and the temperature sensor;
a temperature determination unit that determines whether the measurement data for temperature is higher than a predetermined threshold value based on the measurement data acquired by the information acquisition unit; and
an inflation pressure determination unit that determines, when the temperature determination unit determines that the temperature is higher than the predetermined threshold value, whether a high temperature state in the tire is caused by a factor on a vehicle side or a tire side based on the measurement data for inflation pressure.

2. The tire monitoring system according to claim 1,
wherein, when the inflation pressure is higher than a predetermined threshold value, the inflation pressure determination unit determines that the high temperature state in the tire is caused by a factor on the vehicle side.

3. The tire monitoring system according to claim 1,
wherein the inflation pressure determination unit makes a determination based on inflation pressure data for a predetermined period including a point of time of occurrence of the high temperature state in the tire.

4. The tire monitoring system according to claim 3,
wherein the inflation pressure determination unit determines whether the inflation pressure data is larger a predetermined threshold value.

5. The tire monitoring system according to claim 1, further comprising:
a notification unit that outputs a result of determination by the inflation pressure determination unit outside.

6. The tire monitoring system according to claim 5,
wherein the notification unit outputs a stop instruction to stop the vehicle when the inflation pressure determination unit determines that the high temperature state in the tire is caused by a factor on the vehicle side.

7. The tire monitoring system according to claim 6,
wherein, when the temperature determination unit determines that the temperature of the tire is lower than the threshold value after the notification unit outputs the stop instruction, the notification unit notifies that running of the vehicle can be resumed.

8. The tire monitoring system according to claim 5,
wherein the notification unit generates alert information including tire temperature, factor causing a high temperature state, identification information on a corresponding vehicle, information on a mounting position of the tire in an axle arrangement, and information on date and time and outputs the alert information outside.

9. The tire monitoring system according to claim 1,
wherein, when the temperature determination unit determines that the temperature of the tire is higher than the threshold value, the temperature determination unit outputs a determination result to a storage unit, causing the storage unit to store the determination result as determination result information.

10. The tire monitoring system according to claim 9,
wherein the determination result information includes tire temperature, identification information on a corresponding vehicle, information on a mounting position of the tire in an axle arrangement, and information on date and time.

11. The tire monitoring system according to claim 1,
wherein the inflation pressure determination unit calculates an average value of a tire inflation pressure in a period before the high temperature state in the tire occurs and calculates an amount of decrease in the tire inflation pressure at a point of time of occurrence of the high temperature state in the tire.

12. The tire monitoring system according to claim 1, further comprising:
a temperature trend comparison unit that compares a trend in temperature in a plurality of tires mounted on the vehicle,
wherein, when the temperature trend comparison unit determines that only one of the plurality of tires is in a high temperature state, the inflation pressure determination unit determines whether the high temperature state is caused by a factor on the vehicle side or the tire side.

13. The tire monitoring system according to claim 1, further comprising:
a temperature trend comparison unit that compares a trend in temperature in a plurality of tires mounted on the vehicle,
wherein, when the temperature trend comparison unit determines that the trend in temperature in one of the plurality of tires differs from the trend in temperature in all other tires, the inflation pressure determination unit determines whether the high temperature state is caused by a factor on the vehicle side or the tire side.

14. A tire monitoring method comprising:
acquiring measurement data by an inflation pressure sensor and a temperature sensor provided in a tire mounted on a vehicle;
determining whether the measurement data for temperature is higher than a predetermined threshold value based on the measurement data acquired by the acquiring; and
when the determining determines that the temperature is higher than the predetermined threshold value, determining whether a high temperature state in the tire is caused by a factor on a vehicle side or a tire side based on the measurement data for inflation pressure.
